(19) United States
(12) Patent Application Publication
(10) Pub. No.: US 2014/0005954 A1
(43) Pub. Date: Jan. 2, 2014

(54) Method Of Processing Multidimensional Mass Spectrometry

(71) Applicants: Keith Richardson, New Mills (GB); Richard Denny, Newcastle-under-Lyme (GB)

(72) Inventors: Keith Richardson, New Mills (GB); Richard Denny, Newcastle-under-Lyme (GB)

(73) Assignee: MICROMASS UK LIMITED, Manchester (GB)

(21) Appl. No.: 13/977,865

(22) PCT Filed: Jan. 6, 2012
(86) PCT No.: PCT/GB2012/050022

§ 371 Date: Sep. 16, 2013

Related U.S. Application Data
(60) Provisional application No. 61/434,490, filed on Jan. 20, 2011.

(30) Foreign Application Priority Data
Jan. 10, 2011 (GB) 1100301.9

(51) Int. Cl. H01J 49/00

(52) U.S. Cl. CPC H01J 49/0036
USPC 702/23

(57) ABSTRACT

A method of processing multidimensional data acquired from analytical equipment, which method comprises the steps of providing raw multidimensional data that includes mass spectrometric analytical data obtained from a sample, conducting a first processing step of identifying regions of interest within the raw multidimensional data and conducting a second processing step of refining the raw multidimensional data associated with the one or more regions of interest using peak detection of the mass spectrometric analytical data, wherein the first processing step is conducted using a first processing means and/or a first software program and the second processing step is conducted using a second processing means and/or a second software program, whereby the first and second processing steps are capable of independent implementation.

This invention relates to a method for processing multidimensional data acquired using mass spectrometry (MS) equipment.

The coupling of mass spectrometers to liquid chromatography (LC) equipment has been commonplace for many years, and there are well established techniques for processing the resulting two dimensional (2D) data.

In recent years, additional separation techniques have been employed as an alternative to, or in addition to, LC separation. In particular, ion mobility (IM) separation which operates on a timescale between those of LC and time of flight (TOF) MS analysis is now widespread. This has led to the development of techniques for the processing of three dimensional (3D) LC-IM-MS data.

However, even loop injection or infusion data in which an essentially unchanging sample is introduced into a mass spectrometer with no prior separation can be regarded as 2D since the detected signal varies with time due to counting statistics, fluctuations in electrospray and even deliberate changes in the configuration of the MS or injection apparatus.

Existing techniques for measurement of peak properties in the resulting data involve steps such as averaging or summing the data and application of multidimensional filters to the data. These approaches are useful when the MS detection system is operating in an approximately linear regime. However, all practical detection systems display non-linear behaviour. For example all MS detectors have a saturation characteristic such that there is an upper limit on the ion arrival rate which will result in an output signal that scales in proportion.

In the case of LC analysis, it is often the case that as a particular species begins to elute, it will produce a small MS signal that is well within the linear range of the MS detection system. However, at a slightly later retention time, the signal might saturate the detector. Eventually the signal falls again and the response is once again linearly proportional to the underlying ion arrival rate.

A known method of processing this data involves discarding some of the spectra near the apex of the chromatographic peak. However this method suffers from drawbacks. Firstly, some of the available data is not used for mass measurement and, since the onset of TDC deadtime with ion arrival rate is gradual, the remaining spectra may not be free of deadtime especially if the chromatographic peak width is small compared with the spacing of the acquired spectra. Secondly, this approach does not assist with the repair of the intensity measurement.

It would therefore be desirable to provide a new, improved method and apparatus for the processing of data produced from a mass spectrometer which can reliably, and accurately provide data for regions of interest within the measured data and to improve estimates of the mass and intensity within those regions of interest.

One aspect of the invention provides a method of processing multidimensional data acquired from analytical equipment, which method comprises the steps of providing raw multidimensional data that includes mass spectrometric analytical data obtained from a sample, conducting a first processing step of identifying regions of interest within the raw multidimensional data and conducting a second processing step of refining the raw multidimensional data associated with the one or more regions of interest using peak detection of the mass spectrometric analytical data, wherein the first processing step is conducted using a first processing means and/or a first software program and the second processing step is conducted using a second processing means and/or a second software program, whereby the first and second processing steps are capable of independent implementation.

A second aspect of the present invention provides a method of processing multidimensional data acquired from analytical equipment, which method comprises the steps of providing raw multidimensional data that includes mass spectrometric analytical data obtained from a sample, conducting a first processing step of identifying regions of interest within the raw multidimensional data and conducting a second processing step of refining the raw multidimensional data associated with the one or more regions of interest using peak detection of the mass spectrometric analytical data to account for mass and/or intensity errors in the raw data arising from hardware limitations so as to produce an improved data set, wherein said first and second steps are intuitively linked but capable of independent implementation.

The one or more regions of interest may comprises two or more, e.g. a plurality of, regions of interest. The method may further comprise filtering the regions of interest before the refining step. The first processing step may comprise filtering the regions of interest. Alternatively, the second processing step may comprise filtering the regions of interest.

The analytical equipment may comprise one of more of a mass spectrometer, a liquid chromatograph, an ion mobility cell, an ion mobility time-of-flight mass spectrometer and/or a time-of-flight mass spectrometer A method according to any preceding claim, wherein said multidimensional data comprises LC-MS data.

The multidimensional data may comprise LC-IM-MS data. The hardware limitations may relate to detector deadtime.

In some embodiments, a region of interest response measurement prior to 1D peak detection of spectra overlapping a region of interest is rejected if said measurement fails to meet a predetermined quality or response criteria. The 1D peak detection of spectra overlapping a ROI may include the suppression or rejection of 1D peaks that arrive from interfering species and/or overlapping regions of interest.

Diagnostic information may be obtained, which may comprise interference or detector saturation flags.

The analytical equipment may comprise LC-IM-TOF MS and/or the method may comprise one or more of the following steps: LC separation of a sample in solution; Introduction of said sample into an IM-TOF mass spectrometer to produce a 3D dataset where the dimensions are retention time, ion mobility and time of flight; 3D feature detection by suitable means to produce a list of regions of interest; and Analytically determining the actual mass and intensity data within said regions of interest.

The storage of a resulting list of regions of interest may include one or more of uncertainty in measured RT, uncertainty in measured ion mobility, uncertainty in measured time of flight, interferences and/or saturation flags.

The method may further comprise infusion loop injection data in which the spectra is summed over the experimental duration or over a user-defined subset for region of interest detection, concluding 1D or 2D region of interest detection by any suitable 1D or 2D peak detection algorithm and obtaining a corrected time of flight and intensity.

Further aspects of the invention provide a control system operative or programmed to execute the method or each of the first and second processing steps of the method, an analytical instrument comprising the control system or systems and/or that is operative to carry out or execute the method or each of the first and second processing steps of the method, a computer program element comprising computer readable program code means for causing a processor to execute a procedure to implement the method or each of the first and second processing steps of the method, a computer readable medium embodying the or each computer program element and/or having a program stored thereon, for example where the or each program is to make a computer execute a procedure to implement the method.

For the avoidance of doubt, the first and second processing means may be provided by a single control unit or even a single processor, for example on which two separate programs are run. The provision of separate processing means and/or software programs provides a great deal of flexibility that would be appreciated by those skilled in the art.

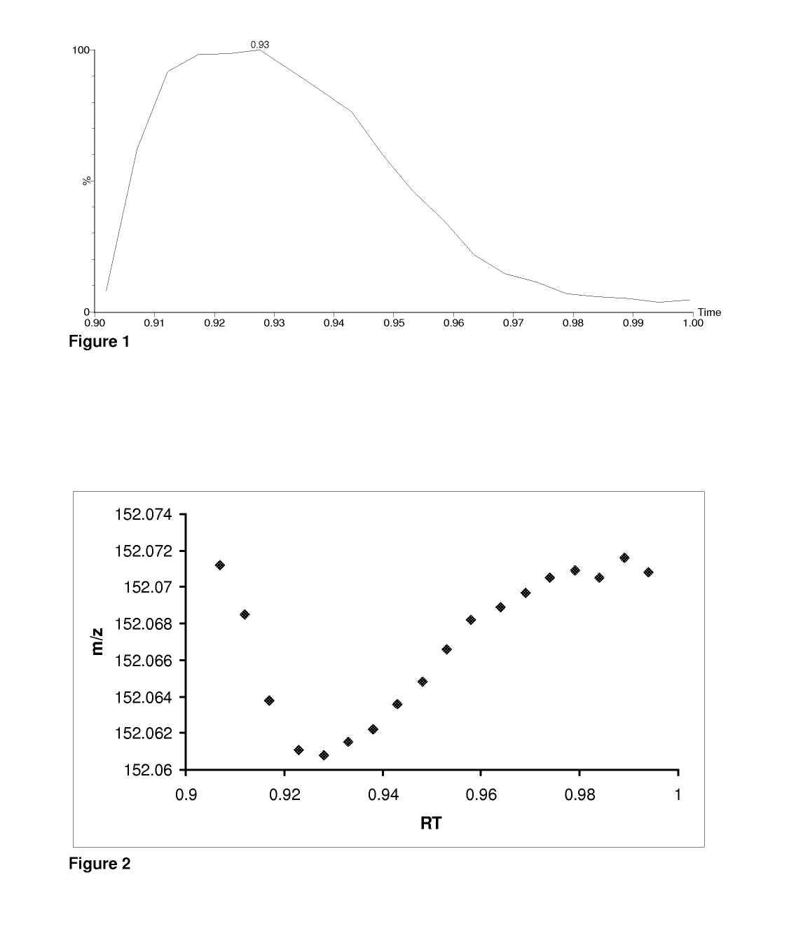

In the accompanying drawings, FIG. 1 shows the TOF MS response of a single species as measured in an LC-MS experiment, and FIG. 2 shows the time of flight measurements obtained by peak detecting every MS spectrum across the peak shown in FIG. 1.

The systematic dip in the measured mass near the apex of the chromatographic peak is due to the behaviour of an edge detecting time to digital converter (TDC). Following an ion arrival this type of TDC is effectively blind to subsequent ion arrivals for a short time corresponding to the detector pulse width. These ion arrivals then further extend the TDC “dead time”. The resultant effect is a peak that is located at an earlier time of flight than the underlying ion arrivals, and an undercounting of ion arrivals.

In the case of TDC detection systems, the number of pushes experienced by an ionic species may not be known precisely perhaps due to passage through a scanning quadrupole followed by fragmentation prior to entry in to a time of flight mass spectrometer. Another data acquisition configuration where the precise number of pushes undergone is uncertain is in asynchronous mobility acquisition. Here, only some of the pushes sample a particular molecular species. Imperfect knowledge of the number of pushes can make alternative methods for dead-time correction unreliable.

It is clear that averaging, summing or smoothing of the spectra shown in FIG. 2 prior to peak detection would cause the observed distortion to propagate to adjacent spectra, making accurate mass measurement difficult or impossible.

It is beneficial to separate the steps of initial feature detection in the LC-MS space from accurate mass measurement and quantification. Thus, it is envisioned that the processing of multidimensional data by the present invention would involve the following processing steps:

1) Location of regions of interest (ROI) or “features” within the analytical space by any suitable means, followed by

2) One dimensional (1D) peak detection of all mass spectra overlapping the region of interest followed by

3) Detailed analysis of the peaks detected within each ROI to obtain high quality measurements of some or all of the properties of the detected feature.

One significant advantage of the method of processing according to the present invention is that a filter may be applied following ROI detection so that the potentially time consuming detailed analysis of regions of interest may be restricted to those that are likely to yield useful information for a particular application. Examples of filter criteria that may be used include, but are not limited to, a response threshold, a signal to noise threshold, quality flags such as peak shape, interference or saturation.

In a preferred embodiment of the invention, features in LC-TOF MS data such as the one previously described are discovered and characterised by a method comprising the following steps:
LC separation of a sample in solution
Introduction of the sample thus separated into a TOF mass spectrometer producing a 2D dataset where the dimensions are retention time and time of flight.
2D feature detection by any suitable means producing a list of ROI defined by the following properties
   retention time limits
   time of flight limits
   measured retention time
   provisional time of flight measurement
   provisional response (accumulated signal) measurement
For each ROI so discovered, the following steps:
   Optional rejection if the ROI response measurement fails to meet some quality or response criteria.
   1D peak detection of spectra overlapping the current ROI
   Inference of a corrected time of flight measurement (approximating that which would be obtained by a hypothetical perfect detector) and a corrected intensity along with associated uncertainties. This step may optionally involve suppression or rejection of detected 1D peaks that arise from interfering species and/or overlapping regions of interest.
   Optionally, collation and propagation of metadata associated with the unprocessed data lying in the ROI and/or diagnostic information obtained from the 1D peak detection such as (but not limited to) interference or detector saturation flags.
Storage of the resulting list of ROI including at least the following
   Measured RT
   Corrected time of flight
   Corrected intensity
and optionally including some or all of the following
   uncertainty in measured RT
   uncertainty in measured time of flight
   interference flags
   saturation flags

A second preferred embodiment of the invention, features in LC-IM-TOF MS data such as the one previously described are discovered and characterised by a method comprising the following steps:
LC separation of a sample in solution
Introduction of the sample thus separated into an IM-TOF mass spectrometer producing a 3D dataset where the dimensions are retention time, ion mobility and time of flight.
3D feature detection by any suitable means producing a list of ROI defined by the following properties
   retention time limits
   ion mobility limits
   time of flight limits
   measured retention time
   measured ion mobility
   provisional measured time of flight
   provisional measured response (accumulated signal
For each ROI so discovered, the following steps:
   1D peak detection of spectra overlapping the current ROI
   Inference of a corrected time of flight measurement (approximating that which would be obtained by a hypothetical perfect detector) and a corrected intensity along with associated uncertainties. This step may optionally involve suppression or rejection of detected 1D peaks that arise from interfering species and/or overlapping regions of interest.
   Optionally, collation and propagation of metadata associated with the unprocessed data lying in the ROI and/or diagnostic information obtained from the 1D peak detection such as (but not limited to) interference or detector saturation flags.
Storage of the resulting list of ROI including at least the following
   Measured RT
   Measured ion mobility
   Corrected time of flight
   Corrected intensity
and optionally including some or all of the following
   uncertainty in measured RT
   uncertainty in measured ion mobility
   uncertainty in measured time of flight
   interference flags
   saturation flags

In a further embodiment, as above but
infusion/loop injection data without ion mobility
Sum spectra over experimental duration or some user-defined subset for purposes of ROI detection
1D ROI detection—any 1D peak detection algorithm
Obtain corrected time of flight and intensity with optional uncertainties and flags

In a further embodiment, as above but
Infusion/loop injection data with ion mobility
Sum spectra over experimental duration or some user-defined subset for purposes of ROI detection
2D ROI detection in time of flight/ion mobility space
Obtain corrected time of flight, ion mobility and intensity with optional uncertainties and flags

In a further embodiment (as above but for LC-Quadrupole MS data).

1. A method of processing multidimensional data acquired from analytical equipment, which method comprises the steps of providing raw multidimensional data that includes mass spectrometric analytical data obtained from a sample, conducting a first processing step of identifying regions of interest within the raw multidimensional data and conducting a second processing step of refining the raw multidimensional data associated with the one or more regions of interest using peak detection of the mass spectrometric analytical data, wherein the first processing step is conducted using a first processing means and/or a first software program and the second processing step is conducted using a second processing means and/or a second software program, whereby the first and second processing steps are capable of independent implementation.

2. A method according to claim 1, wherein the one or more regions of interest comprises a plurality of regions of interest, the method further comprising filtering the regions of interest before the refining step.

3. A method according to claim 2, wherein the first processing step comprises filtering the regions of interest.

4. A method according to claim 2, wherein the second processing step comprises filtering the regions of interest.

5. A method according to claim 1, wherein said analytical equipment comprises a Time of Flight mass spectrometer.

6. A method according to claim 1, wherein said multidimensional data comprises LC-MS data.

7. A method according to claim 1, wherein said multidimensional data comprises LC-IM-MS data.

8. A method according to claim 1, wherein a region of interest response measurement prior to 1D peak detection of spectra overlapping a region of interest is rejected if said measurement fails to meet a predetermined quality or response criteria.

9. A method according to claim 8, wherein the 1D peak detection of spectra overlapping a ROI includes the suppression or rejection of 1D peaks that arrive from interfering species and/or overlapping regions of interest.

10. A method according to claim 1, wherein diagnostic information obtained comprises interference or detector saturation flags.

11. A method according to claim 1, wherein the analytical equipment comprises LC-IM-TOF MS wherein the method comprises the following steps:
LC separation of a sample in solution;
Introduction of said sample into an IM-TOF mass spectrometer to produce a 3D dataset where the dimensions are retention time, ion mobility and time of flight;
3D feature detection by suitable means to produce a list of regions of interest; and,
Analytically determining the actual mass and intensity data within said regions of interest.

12. A method according to claim 1, wherein the storage of a resulting list of regions of interest includes one or more of uncertainty in measured RT, uncertainty in measured ion mobility, uncertainty in measured time of flight, interferences and/or saturation flags.

13. A method according to claim 1 further comprising infusion loop injection data in which the spectra is summed over the experimental duration or over a user-defined subset for region of interest detection, concluding 1D or 2D region of interest detection by any suitable 1D or 2D peak detection algorithm and obtaining a corrected time of flight and intensity.

14. A method of processing multidimensional data acquired from analytical equipment, which method comprises the steps of providing raw multidimensional data that includes mass spectrometric analytical data obtained from a sample, conducting a first processing step of identifying regions of interest within the raw multidimensional data and conducting a second processing step of refining the raw multidimensional data associated with the one or more regions of interest using peak detection of the mass spectrometric analytical data to account for mass and/or intensity errors in the raw data arising from hardware limitations so as to produce an improved data set, wherein said first and second steps are intuitively linked but capable of independent implementation.

15. A method according to claim 14 wherein said hardware limitations relate to detector deadtime.

16. A control system operative or programmed to execute a method according to claim 1.

17. An analytical instrument comprising a control system according to claim 16.

18. An analytical instrument according to claim 17, wherein the instrument comprises one of more of a mass spectrometer, a liquid chromatograph, an ion mobility cell, an ion mobility time-of-flight mass spectrometer and/or a time-of-flight mass spectrometer.

19. A pair of computer program elements each comprising computer readable program code means for causing a processor to execute a procedure to implement, respectively, the first and second processing steps of the method of claim 1.

20. A computer readable medium embodying one or both of a pair of computer program elements according to claim 19.

21. A computer readable medium having a pair of programs stored thereon, where the programs are to make a computer execute a procedure to implement, respectively, the first and second processing steps of the method of claim 1.

22. A control system operative or programmed to execute a method according to claim 14.

23. An analytical instrument comprising a control system according to claim 22.

24. An analytical instrument according to claim 23, wherein the instrument comprises one of more of a mass spectrometer, a liquid chromatograph, an ion mobility cell, an ion mobility time-of-flight mass spectrometer and/or a time-of-flight mass spectrometer.

25. A pair of computer program elements each comprising computer readable program code means for causing a processor to execute a procedure to implement, respectively, the first and second processing steps of the method of claim 14.

26. A computer readable medium embodying one or both of a pair of computer program elements according to claim 25.

27. A computer readable medium having a pair of programs stored thereon, where the programs are to make a computer execute a procedure to implement, respectively, the first and second processing steps of the method of claim 14.
